(19) United States
(12) Patent Application Publication
(10) Pub. No.: US 2002/0074064 A1
(43) Pub. Date: Jun. 20, 2002

(54) Thermal increase device

(76) Inventor: Robert E. Kane, Sandpoint, ID (US)

Correspondence Address: Robert E. Kane, P. O. Box 280, San Luis Rey, CA, 92068, US

(21) Appl. No.: 09/738,746

(22) Filed: Dec. 14, 2000

(51) Int. Cl. H01F 1/04; H01F 1/03

(52) U.S. Cl. 148/301

(57) ABSTRACT

Improvements are described in the use of a neodymium magnetic circuit that creates a strong magnetic field, (of approximately one tesla) that acts as a catalyst through which fuel is passed converting the fuel from para to ortho, changing the spin state of the hydrogen molecule, this greatly enhances the energy of the atom and general fuel reactivity, and combustion efficiency. This magnetic field is utilized by placing the invention over the delivery fuel line as close to the actual flame as possible.

Special housing hold the neodymium magnetic circuit in position.

### BACKGROUND OF THE INVENTION

During the 1950's an American Scientist for NASA, Simon Ruskin was granted a U.S. Utility Pat. No. 328,868. Please note that under U.S.C. 35 section 101, any utility patent must be proven operable and scientifically correct before issuance. This patent states that parahydrogen could be converted to a higher energized orthohydrogen through the stimulation of a proper magnetic field to change the spin state of the hydrogen molecule. In 1977 Van Vleck was awarded the Nobel Prize in Physics jointly with Sir Neville Mott and Philip Anderson “for their fundamental theoretical investigations of the electronic structure of magnetic and disordered systems.” The spin effect of the fuel molecules can be ascertained optically, based on refraction of light rays passing through liquid fuel, as had been demonstrated by scientists while using infrared cameras.

### SUMMARY OF THE INVENTION

In accordance with one aspect of the present invention, a system is provided for all sizes and all dimensions of fuel lines. The invention generates a catalylistic influence within the homogeneous fuel itself, to break up the hydrocarbon chains in the fuel an allow the fuel molecules to unite more completely with oxygen in creating a more complete combustion. When a molecule has a distinctly positive end and a negative end, the permanent force is referred to as a dipole-dipole attraction. The oxygen atoms in fuels are electron-rich, while the carbon atoms in the fuel are electron-poor, so the oxygen atom of the one can be attracted to the other or aligned, (fractured) when influenced by the proper magnetic field. Normally electron-rich and electron-poor regions on the molecule persist for only a short time, but if they can polarize the electron distribution on an adjacent molecule, electron clouds on the two molecules may begin to oscillate (resonate) cooperatively with each other. The dipoles are transitory but aligned, and a net attractive force pulls the oxygen and carbon molecules together. Reactions of the neodymium catalyst with the fuel molecules is immediately apparent as soon as the conditioned fuel reaches the flame. On Dec. 7, 2000 California Environmental Engineering, an Environmental Protection Agency (EPA) recognized Environmental Testing Laboratory, confirmed the findings of increased temperature by this method utilizing this invention, a neodymium compound as a catalyst. A certified copy of that report is enclosed as part of this application.

### OPERATION

To understand the operation of the invention we must look at Hydrogen, the lightest and most basic element known to man, and is the major constituent of hydro-carbon fuels (besides carbon and smaller amount of sulfur and inert gases). It has one positive charge (proton) and one negative charge (electron), i.e. it possesses a dipole moment. It can be either diamagnetic or paramagnetic (weaker or stronger response to the magnetic flux) depending on the relative orientation of its nucleus spins. Thus, and even though it is the simplest of all elements, it occurs in two distinct isomeric varieties (forms)—para and ortho, characterized by the different opposite nucleus spins. And thus in para H2 molecule, which occupies the even rotation levels (quantum number), the spin state of one atom relative to another is in the opposite direction (“counterclockwise”, “antiparallel”, “one up & one down”) rendering it diamagnetic, whereas in the ortho molecule, which occupies the odd rotational levels, the spins are parallel (“clockwise”, “coincident”, “both up”), with the same orientation for the two atoms, and therefore is paramagnetic and a catalyst for many reactions. Thus the spin orientation has a pronounced effect on physical properties (specific heat, vapor pressure), as well as behavior of the gas molecule.

To secure conversion of para to ortho state, it is necessary to change the energy of interaction between the spin state of the H2 molecule. Altering the spin properties of the outer shell (“valance”) electron enhances the reactivity of the fuel (and related combustion process). The higher energized spin state of the hydrogen molecule clearly shows a high electrical potential (reactivity) which attracts additional oxygen. Combustion engineering teaches that additional oxygenation increases combustion efficiency. Therefore by altering the spin properties of the H2 molecule, we can give rise to its magnetic moment and enhance the reactivity of the hydrocarbon fuel and ameliorate the related combustion process, changing the isomeric form of the hydrocarbon atom from its para-hydrogen state to the higher energized, more volatile, ortho state, thus attracting additional oxygen. Fuel structure and properties, such as e.g. electrical conductivity, density, viscosity or light extinction are changed, its microstructure beneficially homogenized. Hydrocarbon molecules form clusters, called associations (chains). It is technically possible to enhance Van der Waals' discovery due to the application of this invention that delivers a high power, permanent magnetic device, strong enough to cause a catalyst reaction that in turn fracture these chains of hydrocarbons. They become normalized and independent, distanced from each other, having larger surface available for binding (attraction) with more oxygen (better oxidation). As fuel runs through the field of influence, the invention acts as a catalyst to bring about the chemical reaction.

The chief reason for this invention is to have a positive reaction in raising the temperature (increasing the efficiency) of the basic flame to such an extent that nitrogen oxide compounds will be eliminated as there will be no more oxygen left over to form the unwanted nitrogen compounds.

### REFERENCE

“Van der Waals” and “London Forces” http://antoine.fsu.umd.edu/chem/senese/101/liquids/faq/h-bonding-vs-london-forces.shtml

### BRIEF DESCRIPTION OF THE DRAWINGS

FIG. 1 is a simplified schematic overview of an embodiment capable of housing the invention, two magnetic conductors of the apparatus of the present invention installed therein.

FIG. 2 is an isometric view of the invention.

FIG. 3. is an isometric view of the top of a suitable housing.

FIG. 4. is an isometric view of the retainer portion of the housing that will enclose the invention.

FIG. 5. is an isometric view of the under side of an embodiment that encapsulates the invention.

### DESCRIPTION OF THE PREFERRED EMBODIMENTS

FIG. 1 illustrates a system of the present invention that is placed over the fuel line in pairs. It is placed as close to the flame as possible.

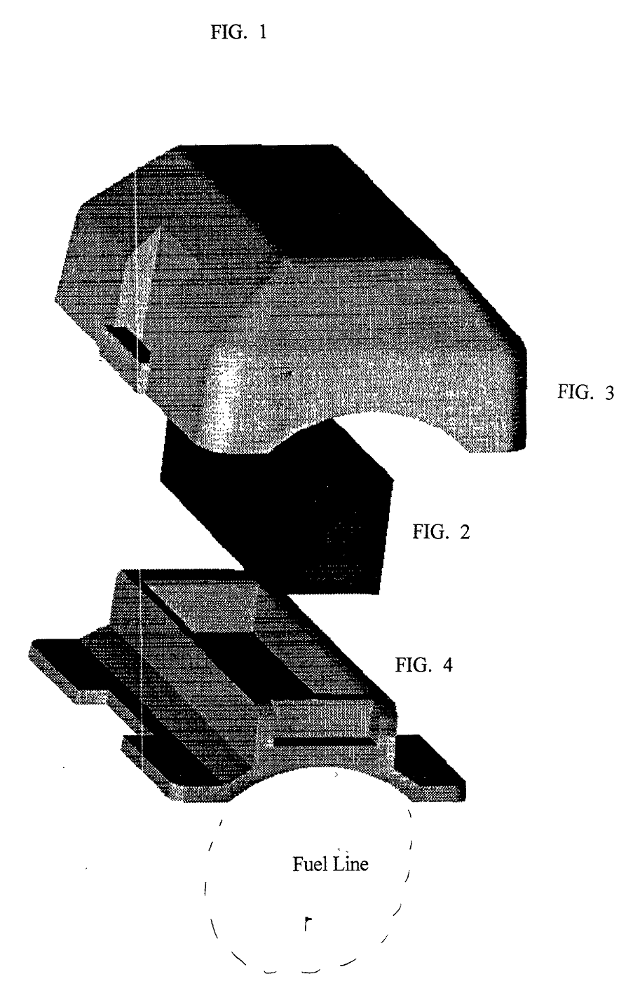

FIG. 2 shows the invention at or about one inch long and 0.375 inches wide and high. The surface gauss reading at not less than 3000 gauss. with a Br of approx. 13000 gauss.

FIG. 3 shows the top of a suitable housing possibly made out of an nylon injected material. Approx. outside dimensions of 1¼ w.×¾ h.×1⅞ inches long.

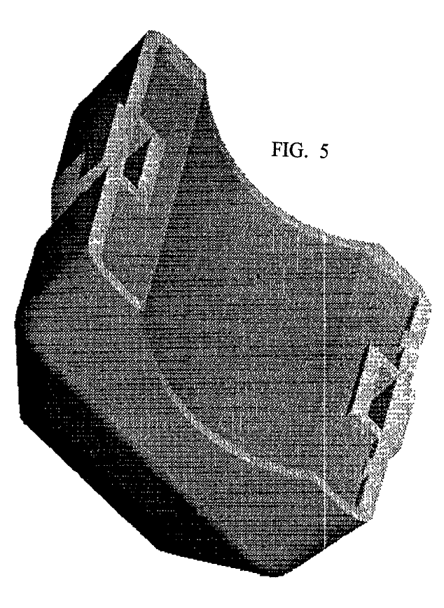

FIG. 4 shows a retainer portion of the housing that aligns the invention.

FIG. 5 illustrates the under portion or that point which comes in contact with the fuel line. The radius of which will be about 1″ inch. Note: Two parts align across from each other.

Although particular embodiments of the invention have been described and illustrated herein, it is recognized that modifications and variations may readily occur to those skilled in the art, and consequently, it is intended that the claims be interpreted to cover such modifications and equivalents.

1. A conductor of magnetic material used as a catalyst for inducing Van der Waals and London Forces inturn producing higher burning temperatures of the basic flame, indicating more efficiency and the reduction of oxides of nitrogen.

2. The invention described in claim 1 wherein:
The material consists of a blended formula that forms high coercively intermetallic phases having an energy product at magnetic saturation of at least 10 mega Gauss Oersteds, comprising at least 10 to 40 atomic percent of neodymium and praseodymium, and at least about 50 to 90 atomic percent total transition metal elements consisting of mixtures of iron and cobalt where the amount of said cobalt mixture is less than 40 percent.

3. The invention described in claim 1 wherein:
The surface gauss is 3000 or more. each pc.×2

4. The invention described in claim 1 wherein:
The operational temperature is 230 F. and above.

5. The invention described in claim 1 wherein:
The Br is 12000 or more. Flux density (gauss) (Tesla) (lines/in2)

6. The invention described in claim 1 wherein:
The physical dimensions are at least ½″ long or round and 0.250 thick or more.

7 . The invention described in claim 1 wherein:
The material is magnetized through the thickness.

8. The invention described in claim 1 wherein:
The conductors (2) are aligned 180 degrees apart.

9. The invention described in claim 1 & 8 wherein:
The magnetic poles are positioned across from each other 180 degrees and magnetically attracting (one North and one South)

10. The invention described in claim 1 wherein:
The BHmax is 27 or more.
